(19) United States
(12) Patent Application Publication
(10) Pub. No.: US 2005/0048669 A1
(43) Pub. Date: Mar. 3, 2005

(54) Gasketless microfluidic device interface

(75) Inventors: Steven E. Hobbs, West Hills, CA (US); Christoph D. Karp, Pasadena, CA (US)

Correspondence Address: NANOSTREAM, INC., 580 SIERRA MADRE VILLA AVE., PASADENA, CA, 91107-2928, US

(73) Assignee: Nanostream, Inc.

(21) Appl. No.: 10/649,073

(22) Filed: Aug. 26, 2003

(51) Int. Cl. G01N 1/10

(52) U.S. Cl. 436/180; 422/100

(57) ABSTRACT

Gasketless interfaces between microfluidic devices and related systems or instruments are provided. A microfluidic device includes a plastically deformable outer layer defining at least one port. An external mating surface having a protruding feature is aligned with the fluidic port defined in the microfluidic device. An actuator depresses at least a portion of the protruding feature into the outer layer adjacent to the fluidic port to cause the protruding feature to plastically deform the outer layer so as to form a reverse impression of the feature. Preferred materials are non-degrading in the presence of and non-absorptive of samples and solvents typically utilized in performing liquid chromatography. Systems for performing chromatography utilizing gasketless interconnects and at least one method for fabricating a multi-feature seal plate are provided.

### FIELD OF THE INVENTION

The present invention relates to interfaces between microfluidic devices and related instruments or systems.

### BACKGROUND OF THE INVENTION

There has been a growing interest in the application of microfluidic systems to a variety of technical areas, including such diverse fields as biochemical analysis, medical diagnostics, chemical synthesis, and environmental monitoring. Microfluidic systems provide certain advantages in acquiring chemical and biological information. For example, microfluidic systems permit complicated processes to be carried out using very small volumes of fluid, thus minimizing consumption of both samples and reagents. Chemical and biological reactions occur more rapidly when conducted in microfluidic volumes. Furthermore, microfluidic systems permit large numbers of complicated biochemical reactions and/or processes to be carried out in a small area (such as within a single integrated device) and facilitate the use of common control components. Examples of desirable applications for microfluidic technology include analytical chemistry; chemical and biological synthesis; DNA amplification; and screening of chemical and biological agents for activity, among others.

Among the various branches of analytical chemistry, the field of chromatography stands to particularly benefit from the application of microfluidic technology due to higher efficiency and increased throughput (afforded by performing multiple analyses in parallel in a miniaturized format). Chromatography encompasses a number of methods that are used for separating closely related components of mixtures. In fact, chromatography has many applications including separation, identification, purification, and quantification of compounds within various mixtures.

Liquid chromatography is a physical method of separation wherein a liquid “mobile phase” (typically consisting or one or more solvents) carries a sample containing multiple constituents or species through a “stationary phase” material (e.g., packed particles having functional groups and disposed within a tube) commonly referred to as a “separation column”. A sample is supplied to a separation column (stationary phase material) and carried by the mobile phase. As the sample solution flows with the mobile phase through the stationary phase, components of the sample solution will migrate according to interactions with the stationary phase and these components are retarded to varying degrees. The time a particular component spends in the stationary phase relative to the fraction of time it spends in the mobile phase will determine its velocity through the column. Following chromatographic separation in the column, the resulting eluate stream (consisting of mobile phase and sample components) contains a series of regions having elevated concentrations of individual species, which can be detected by various techniques to identify and/or quantify the species.

Although pressure-driven flow or electrokinetic (voltage-driven) flow can be used in liquid chromatography, pressure-driven flow is desirable since it permits a wider range of samples and solvents to be used and it avoids problems associated with high voltage systems (such as hydrolysis, which can lead to detrimental bubble formation). Within pressure-driven systems, higher pressures generally provide greater separation efficiencies, such that pressures of several hundred to thousands of pounds per square inch (psi) are used in conventional liquid chromatography systems. One difficulty associated with high pressure systems is providing reliable fluidic interconnects. Conventional tube-based chromatography systems—inclusive of both macro-scale tubing and capillary tubing variants—typically utilize low-dead-volume threaded fittings. These fittings, however, are not well-suited for use in complex systems for performing high throughput (i.e., parallel) separations because they require time-consuming assembly and they are difficult to automate, requiring automation systems capable of performing complex tasks such as precisely aligning components and rotating screw fittings.

Various other types of fluidic interconnects for microfluidic systems are known. For example, WIPO published application number WO 01/09598 to Holl, et al., discloses a fluidic interconnect between a manifold having a protruding feature and a microfluidic device having an elastomeric outer layer. A bore defined in the protruding feature of the manifold is aligned with a bore in the elastomeric outer layer of the microfluidic device such that when the protruding feature is pressed against the elastomeric outer layer, fluid can be communicated from the manifold into the microfluidic device or vice-versa.

This interconnect design, however, is not well-suited for use in chromatography systems for a number of reasons. To begin with, elastomeric materials are subject to chemical degradation and swelling when exposed to chemicals typically employed in performing chromatography (particularly organic solvents such as acetonitrile, methanol, isopropyl alcohol, ethanol, ethyl acetate, and dimethyl sulfoxide). Any products of such degradation can be carried into an eluent stream and potentially interfere with sample analysis. Elastomeric materials also present sample carryover (contaminations problems in multi-use systems since such materials are often capable of retaining samples (e.g., through absorption or adsorption) used in one experimental run and then releasing such samples (e.g., through desorption) in a subsequent run. Moreover, elastomeric materials are subject to mechanical wear, thus conferring limited service life to components constructed with them.

Further examples of conventional interconnect designs are provided in U.S. Pat. No. 6,240,790 to Swedberg, et al. One design disclosed by Swedberg, et al. includes the use of O-rings and bosses (raised surfaces surrounding a central hole or fluid port). Most conventional O-rings, however, are soft materials that suffer from the same or similar drawbacks to the elastomeric materials discussed previously. Additionally, O-ring designs are often ill suited for repeated connection/disconnection cycles since O-rings can come loose from their associated bosses. Another design disclosed by Swedberg, et al. includes the use of adhesives or other material joining techniques including direct bonding and ultrasonic welding. Such designs usually provide permanent connections that are incompatible with processes that require periodic access to a fluidic port, such as for loading samples into a chromatography system. If releasable (non-permanent) adhesives are used, the resulting interconnects typically pose chemical compatibility problems and may not seal against high operating pressures.

In light of the foregoing, it would be desirable to provide interfaces with microfluidic devices capable of leak-free operation at high pressures. It would be desirable to provide interfaces that are physically compact, that permit rapid sealing and unsealing utility, and are characterized by low overall volume. It would be desirable if such interfaces were resistant to chemical degradation when exposed to chemicals typically used in liquid chromatography systems. It would be further desirable if such interfaces were resistant to chemical absorption or adsorption.

### BRIEF DESCRIPTION OF THE DRAWINGS

FIG. 1A is a top view of a multi-channel seal plate defining twenty-four protruding annular features each surrounding a different fluidic passage.

FIG. 1B is a side view of the seal plate of FIG. 1A.

FIG. 1C is an end view of the seal plate of FIGS. 1A-1B.

FIG. 1D is a partial cross-sectional view of a protruding annular feature along section line “A”-“A” (illustrated in FIG. 1A).

FIG. 2A is a side view of a modified endmill adapted to define a raised annular feature such as the raised features depicted FIGS. 1A-1D.

FIG. 2B is a perspective view of the modified endmill of FIG. 2A.

FIG. 3A is a side schematic view of a multi-layer microfluidic device placed into a clamping apparatus in a first state of operation, the clamping apparatus including the multi-channel seal plate illustrated in FIGS. 1A-1D.

FIG. 3B is a side schematic view of the microfluidic device and clamping apparatus of FIG. 3A in a second state of operation.

FIG. 4A is a partial cross-sectional view of the seal plate of FIGS. 1A-1D mated with the microfluidic device of FIG. 5 and FIGS. 6A-6E, illustrated along section line “B”-“B” of FIG. 5.

FIG. 4B is a partial cross-sectional view of the microfluidic device of FIG. 5 and FIGS. 6A-6E along section line “B”-“B” showing a reverse impression or indentation in the outer layer of the device caused by a protruding feature of the seal plate.

FIG. 5 is a top view of a multi-layer microfluidic device containing twenty-four separation columns suitable for performing pressure-driven liquid chromatography.

FIG. 6A is an exploded perspective view of a first portion, including the first through fourth layers, of the microfluidic device shown in FIG. 5.

FIG. 6B is an exploded perspective view of a second portion, including the fifth and sixth layers, of the microfluidic device shown in FIG. 5.

FIG. 6C is an exploded perspective view of a third portion, including the seventh and eighth layers, of the microfluidic device shown in FIG. 5.

FIG. 6D is an exploded perspective view of a fourth portion, including the ninth through twelfth layers, of the microfluidic device shown in FIG. 5.

FIG. 6E is a reduced size composite of FIGS. 6A-6D showing an exploded perspective view of the microfluidic device of FIG. 5.

FIG. 7 is a schematic of a system for performing high throughput pressure-driven liquid chromatography utilizing a microfluidic device having a plastically deformable outer layer.

None of the figures are drawn to scale unless indicated otherwise. The size of one figure relative to another is not intended to be limiting, since certain figures and/or features may be expanded to promote clarity in the description.

### DETAILED DESCRIPTION OF PREFERRED EMBODIMENTS

Definitions

The term “collapse” as used herein refers to a substantially complete closure or blockage of a fluidic channel, such as may be caused by compressing the upper and lower boundaries of a channel together.

The terms “column” or “separation column” as used herein are used interchangeably and refer to a region of a fluidic device that contains stationary phase material and is adapted to perform a separation process.

The term “elastic deformation” as used herein refers to deformation that completely disappears following the removal of an external stress from a material.

The term “elastomer” as used herein refers to a polymeric material that is crosslinked to form a network structure, and characterized by the ability to return to its original dimensions after the removal of external stresses.

The term “fluidic distribution network” refers to an interconnected, branched group of channels and/or conduits capable of adapted to divide a fluid stream into multiple substreams.

The term “frit” refers to a liquid-permeable material adapted to retain stationary phase material within a separation column.

The term “microfluidic” as used herein refers to structures or devices through which one or more fluids are capable of being passed or directed and having at least one dimension less than about 500 microns.

The term “parallel” as used herein refers to the ability to concomitantly or substantially concurrently process two or more separate fluid volumes, and does not necessarily refer to a specific channel or chamber structure or layout.

The term “plastic deformation” as used herein refers to deformation that remains permanently following the removal of external stress from a material.

The term “plurality” as used herein refers to a quantity of two or more.

The term “stencil” as used herein refers to a material layer or sheet that is preferably substantially planar through which one or more variously shaped and oriented portions have been cut or otherwise removed through the entire thickness of the layer, and that permits substantial fluid movement within the layer (e.g., in the form of channels or chambers, as opposed to simple through-holes for transmitting fluid through one layer to another layer). The outlines of the cut or otherwise removed portions form the lateral boundaries of microstructures that are formed when a stencil is sandwiched between other layers such as substrates and/or other stencils.

Microfluidic Devices Generally

Traditionally, microfluidic devices have been fabricated from rigid materials such as silicon or glass substrates using surface micromachining techniques to define open channels and then affixing a cover to a channel-defining substrate to enclose the channels. There now exist a number of well-established techniques for fabricating microfluidic devices, including machining, micromachining (including, for example, photolithographic wet or dry etching), micromolding, LIGA, soft lithography, embossing, stamping, surface deposition, and/or combinations thereof to define apertures, channels or chambers in one or more surfaces of a material or that penetrate through a material.

A preferred method for constructing microfluidic devices utilizes stencil fabrication, which includes the lamination of at least three device layers including at least one stencil layer or sheet defining one or more microfluidic channels and/or other microstructures. As noted previously, a stencil layer is preferably substantially planar and has a channel or chamber cut through the entire thickness of the layer to permit substantial fluid movement within that layer. Various means may be used to define such channels or chambers in stencil layers. For example, a computer-controlled plotter modified to accept a cutting blade may be used to cut various patterns through a material layer. Such a blade may be used either to cut sections to be detached and removed from the stencil layer, or to fashion slits that separate regions in the stencil layer without removing any material. Alternatively, a computer-controlled laser cutter may be used to cut portions through a material layer. While laser cutting may be used to yield precisely dimensioned microstructures, the use of a laser to cut a stencil layer inherently involves the removal of some material. Further examples of methods that may be employed to form stencil layers include conventional stamping or die-cutting technologies, including rotary cutters and other high throughput auto-aligning equipment (sometimes referred to as converters). The above-mentioned methods for cutting through a stencil layer or sheet permits robust devices to be fabricated quickly and inexpensively compared to conventional surface micromachining or material deposition techniques that are conventionally employed to produce microfluidic devices.

After a portion of a stencil layer is cut or removed, the outlines of the cut or otherwise removed portions form the lateral boundaries of microstructures that are completed upon sandwiching a stencil between substrates and/or other stencils. The thickness or height of the microstructures such as channels or chambers can be varied by altering the thickness of the stencil layer, or by using multiple substantially identical stencil layers stacked on top of one another. When assembled in a microfluidic device, the top and bottom surfaces of stencil layers mate with one or more adjacent layers (such as stencil layers or substrate layers) to form a substantially enclosed device, typically having at least one inlet port and at least one outlet port.

A wide variety of materials may be used to fabricate microfluidic devices having sandwiched stencil layers, including polymeric, metallic, and/or composite materials, to name a few. Various preferred embodiments utilize porous materials including filtration media. Substrates and stencils may be substantially rigid or flexible. Selection of particular materials for a desired application depends on numerous factors including: the types, concentrations, and residence times of substances (e.g., solvents, reactants, and products) present in regions of a device; temperature; pressure; pH; presence or absence of gases; and optical properties. For instance, particularly desirable polymers include polyolefins, more specifically polypropylenes, and vinyl-based polymers.

Various means may be used to seal or bond layers of a device together. For example, adhesives may be used. In one embodiment, one or more layers of a device may be fabricated from single- or double-sided adhesive tape, although other methods of adhering stencil layers may be used. Portions of the tape (of the desired shape and dimensions) can be cut and removed to form channels, chambers, and/or apertures. A tape stencil can then be placed on a supporting substrate with an appropriate cover layer, between layers of tape, or between layers of other materials. In one embodiment, stencil layers can be stacked on each other. In this embodiment, the thickness or height of the channels within a particular stencil layer can be varied by varying the thickness of the stencil layer (e.g., the tape carrier and the adhesive material thereon) or by using multiple substantially identical stencil layers stacked on top of one another. Various types of tape may be used with such an embodiment. Suitable tape carrier materials include but are not limited to polyesters, polycarbonates, polytetrafluoroethlyenes, polypropylenes, and polyimides. Such tapes may have various methods of curing, including curing by pressure, temperature, or chemical or optical interaction. The thickness of these carrier materials and adhesives may be varied.

Device layers may be directly bonded without using adhesives to provide high bond strength (which is especially desirable for high-pressure applications) and eliminate potential compatibility problems between such adhesives and solvents and/or samples. For example, in one embodiment, multiple layers of 7.5-mil (188 micron) thickness “Clear Tear Seal” polypropylene (American Profol, Cedar Rapids, Iowa) including at least one stencil layer may be stacked together, placed between glass platens and compressed to apply a pressure of 0.26 psi (1.79 kPa) to the layered stack, and then heated in an industrial oven for a period of approximately five hours at a temperature of 154° C. to yield a permanently bonded microstructure well-suited for use with high-pressure column packing methods. In another embodiment, multiple layers of 7.5-mil (188 micron) thickness “Clear Tear Seal” polypropylene (American Profol, Cedar Rapids, Iowa) including at least one stencil layer may be stacked together. Several microfluidic device assemblies may be stacked together, with a thin foil disposed between each device. The stack may then be placed between insulating platens, heated at 152° C. for about 5 hours, cooled with a forced flow of ambient air for at least about 30 minutes, heated again at 146° C. for about 15 hours, and then cooled in a manner identical to the first cooling step. During each heating step, a pressure of about 0.37 psi (2.55 kPa) is applied to the microfluidic devices.

Notably, stencil-based fabrication methods enable very rapid fabrication of devices, both for prototyping and for high-volume production. Rapid prototyping is invaluable for trying and optimizing new device designs, since designs may be quickly implemented, tested, and (if necessary) modified and further tested to achieve a desired result. The ability to prototype devices quickly with stencil fabrication methods also permits many different variants of a particular design to be tested and evaluated concurrently.

In addition to the use of adhesives and the adhesiveless bonding method discussed above, other techniques may be used to attach one or more of the various layers of microfluidic devices useful with the present invention, as would be recognized by one of ordinary skill in attaching materials. For example, attachment techniques including thermal, chemical, or light-activated bonding steps; mechanical attachment (such as using clamps or screws to apply pressure to the layers); and/or other equivalent coupling methods may be used.

Microfluidic Chromatography Devices

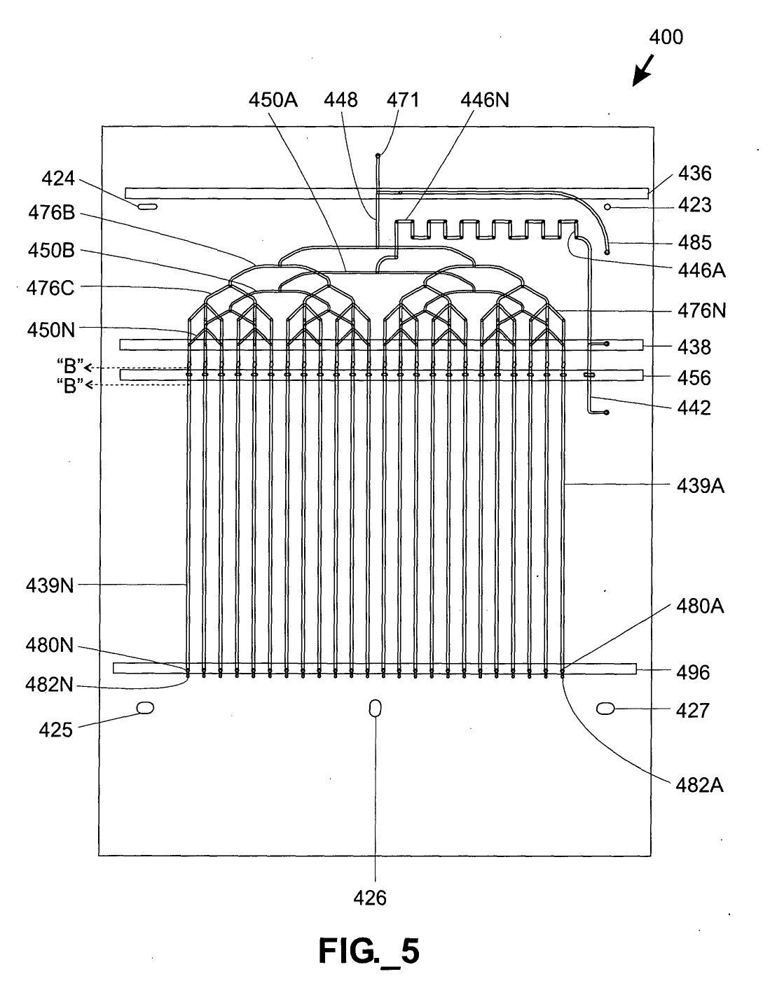

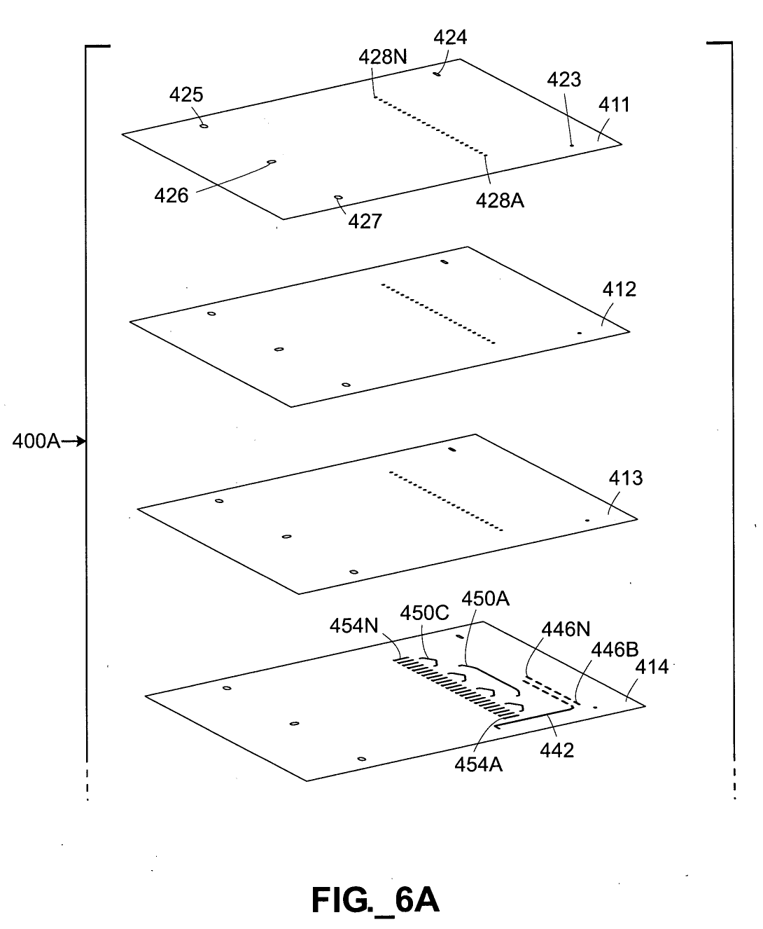

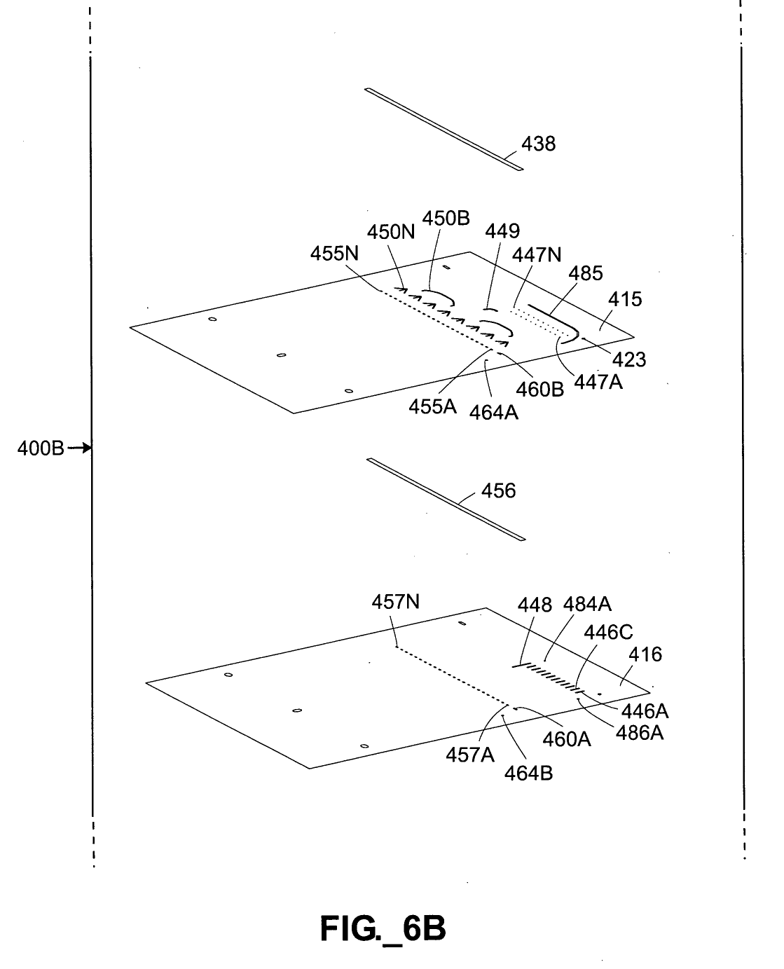

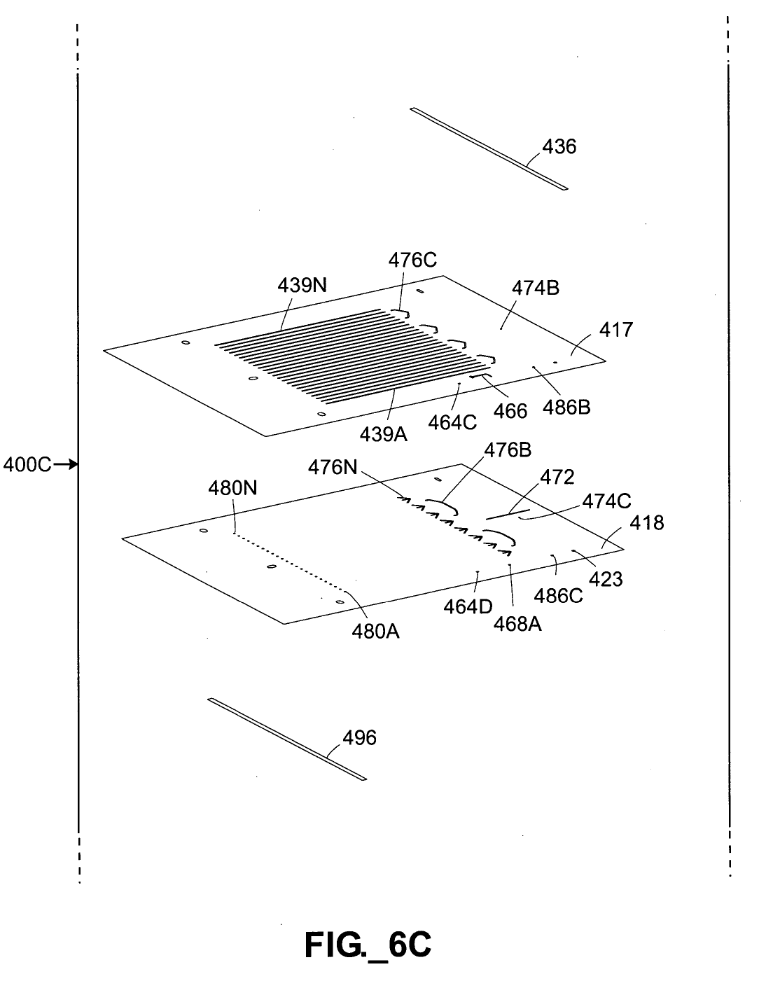

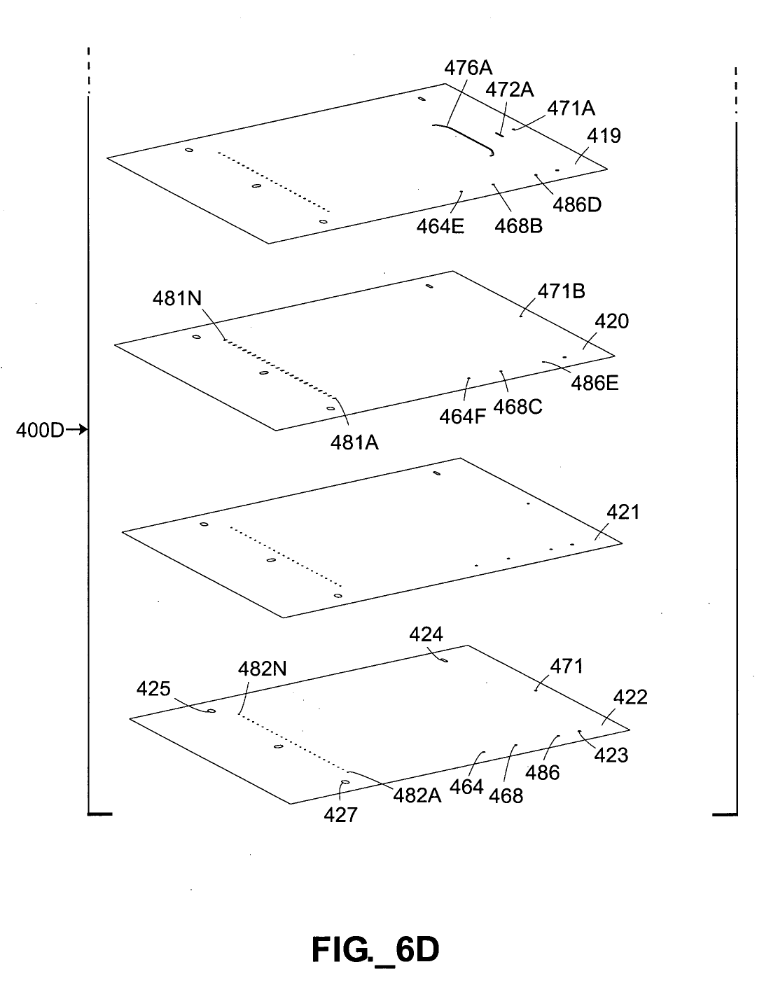

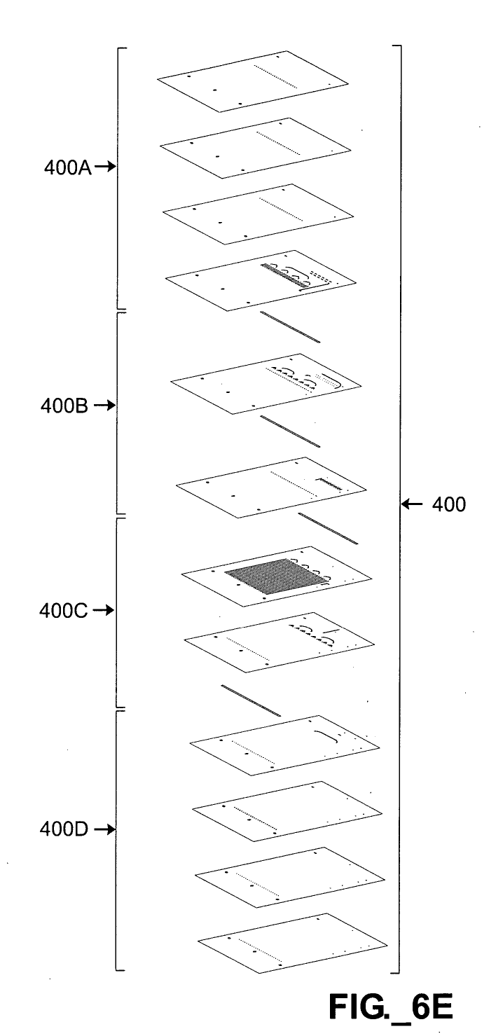

One advantage of performing chromatography in a microfluidic format is that multiple separations can be performed in parallel with a single chromatography system. If multiple columns are provided in a single separation device, then such a device preferably has at least one associated fluidic distribution network to permit operation with a minimum number of expensive (typically external) system components such as pumps and pulse dampers. One example of a multi-column microfluidic separation device suitable for performing pressure-driven liquid chromatography is provided in FIG. 5 and FIGS. 6A-6E. The device 400 includes twenty-four parallel separation channels 439A-439N containing stationary phase material. (Although FIG. 5 and FIGS. 6A-6E show the device 400 having eight separation columns 439A-439N, it will be readily apparent to one skilled in the art that any number of columns 439A-439N may be provided. For this reason, the designation “N” represents a variable and could represent any desired number of columns. This convention is used throughout this document.)

The device 400 may be constructed with twelve device layers 411-422, including multiple stencil layers 414-420 and two outer or cover layers 411, 422. Each of the twelve device layers 411-422 defines five alignment holes 423-427 (with hole 424 configured as a slot), which may be used in conjunction with external pins (not shown) to aid in aligning the layers during construction or in aligning the device 400 with an external interface (not shown) during a packing process or during operation of the device 400. Preferably, the device 400 is constructed with materials selected for their compatibility with chemicals typically utilized in performing high performance liquid chromatography, including, water, methanol, ethanol, isopropanol, acetonitrile, ethyl acetate, dimethyl sulfoxide, and mixtures thereof. Specifically, the device materials should be substantially non-absorptive of, and substantially non-degrading when placed into contact with, such chemicals. Suitable device materials include polyolefins such as polypropylene, polyethylene, and copolymers thereof, which have the further benefit of being substantially optically transmissive so as to aid in performing quality control routines (including checking for fabrication defects) and in ascertaining operational information about the device or its contents. For example, each device layer 411-422 may be fabricated from 7.5 mil (188 micron) thickness “Clear Tear Seal” polypropylene (American Profol, Cedar Rapids, Iowa).

Broadly, the device 400 includes various structures adapted to distribute particulate-based slurry material among multiple separation channels 439A-439N (to become separation columns upon addition of stationary phase material), to retain the stationary phase material within the device 400, to mix and distribute mobile phase solvents among the separation channels 439A-439N, to receive samples, to convey eluate streams from the device 400, and to convey a waste stream from the device 400.

The first through third layers 411-413 of the device 400 are identical and define multiple sample ports/vias 428A-428N that permit samples to be supplied to channels 454A-454N defined in the fourth layer 414. While three separate identical layers 411-413 are shown (to promote strength and increase the aggregate volume of the sample ports/vias 428A-428N to aid in sample loading), a single equivalent layer (not shown) having the same aggregate thickness could be substituted. The fourth through sixth layers 414-416 define a mobile phase distribution network 450 (including elements 450A-450N) adapted to split a supply of mobile phase solvent among twenty-four channel loading segments 454A-454N disposed just upstream of a like number of separation channels (columns) 439A-439N. Upstream of the mobile phase distribution network 450, the fourth through seventh layers 414-417 further define mobile phase channels 448-449 and structures for mixing mobile phase solvents, including a long mixing channel 442, wide slits 460A-460B, alternating channel segments 446A-446N (defined in the fourth and sixth layers 414-416) and vias 447A-447N (defined in the fifth layer 415).

Preferably, the separation channels 439A-439N are adapted to contain stationary phase material such as, for example, silica-based particulate material to which hydrophobic C-18 (or other carbon-based) functional groups have been added. One difficulty associated with prior microfluidic devices has been retaining small particulate matter within separation columns during operation. The present device 400 overcomes this difficulty by the inclusion of a downstream porous frit 496 and a sample loading porous frit 456. Each of the frits 456, 496 (and frits 436, 438) may be fabricated from strips of porous material, e.g., 1-mil thickness Celgard 2500 membrane (55% porosity, 0.209×0.054 micron pore size, Celgard Inc., Charlotte, N.C.) and inserted into the appropriate regions of the stacked device layers 411-422 before the layers 411-422 are laminated together. The average pore size of the frit material should be smaller than the average size of the stationary phase particles. Preferably, an adhesiveless bonding method such as one of the methods described previously herein is used to bond the device layers 411-422 (and frits 436, 438, 456, 496) together. Such methods are desirably used to promote high bond strength (e.g., to withstand operation at high internal pressures of preferably at least about 100 psi (690 kPa), more preferably at least about 500 psi (3450 kPa)) and to prevent undesirable interaction between any bonding agent and solvents and/or samples to be supplied to the device 400.

A convenient method for packing stationary phase material within the separation channels 439A-439N is to provide it to the device in the form of a slurry (i.e., particulate material mixed with a solvent such as acetonitrile). Slurry is supplied to the device 400 by way of a slurry inlet port 471 and channel structures defined in the seventh through ninth device layers 417-419. Specifically, the ninth layer 419 defines a slurry via 471A, a waste channel segment 472A, and a large forked channel 476A. The eighth device layer 418 defines two medium forked channels 476B and a slurry channel 472 in fluid communication with the large forked channel 476A defined in the ninth layer 419. The eighth layer 418 further defines eight smaller forked channels 476N each having three outlets, and twenty-four column outlet vias 480A-480N. The seventh layer 417 defines four small forked channels 476C in addition to the separation channels 439A-439N. In the aggregate, the large, medium, small, and smaller forked channels 476A-476N form a slurry distribution network that communicates slurry from a single inlet (e.g., slurry inlet port 471) to twenty-four separation channels 439A-439N (to become separation columns 439A-439N upon addition of stationary phase material). Upon addition of particulate-containing slurry to the separation channels 439A-439N, the particulate stationary phase material is retained within the separation channels by one downstream porous frit 496 and by one sample loading porous frit 456. After stationary phase material is packed into the columns 439A-439N, a sealant (preferably substantially inert such as UV-curable epoxy) is added to the slurry inlet port 471 to prevent the columns from unpacking during operation of the device 400. The addition of sealant should be controlled to prevent blockage of the waste channel segment 472A.

To prepare the device 400 for operation, one or more mobile phase solvents may be supplied to the device 400 through mobile phase inlet ports 464, 468 defined in the twelfth layer 422. These solvents may be optionally pre-mixed upstream of the device 400 using a conventional micromixer. Alternatively, these solvents are conveyed through several vias (464A-464F, 468A-468C) before mixing. One solvent is provided to the end of the long mixing channel 442, while the other solvent is provided to a short mixing segment 466 that overlaps the mixing channel 442 through wide slits 460A-460B defined in the fifth and sixth layers 415, 416, respectively. One solvent is layered atop the other across the entire width of the long mixing channel 442 to promote diffusive mixing. To ensure that the solvent mixing is complete, however, the combined solvents also flow through an additional mixer composed of alternating channel segments 446A-446N and vias 447A-447N. The net effect of these alternating segments 446A-446N and vias 447A-447N is to cause the combined solvent stream to contract and expand repeatedly, augmenting mixing between the two solvents. The mixed solvents are supplied through channel segments 448, 449 to the distribution network 450 including one large forked channel 450A each having two outlets, two medium forked channels 450B each having two outlets, four small forked channels 450C each having two outlets, and eight smaller forked channels 450N each having three outlets.

Each of the eight smaller forked channels 450A-450N is in fluid communication with three of twenty-four sample loading channels 454A-454N. Additionally, each sample loading channel 454A-454N is in fluid communication with a different sample loading port 428A-428N. Two porous frits 438, 456 are disposed at either end of the sample loading channels 454A-454N. While the first frit 438 technically does not retain any packing material within the device, it may be fabricated from the same material as the second frit 456, which does retain packing material within the columns 439A-439N by way of several vias 457A-457N. To prepare the device 400 for sample loading, solvent flow is temporarily interrupted, an external interface (not shown) previously covering the sample loading ports 428A-428N is opened, and samples are supplied through the sample ports 428A-428N into the sample loading channels 454A-454N. The first and second frits 438, 456 provide a substantial fluidic impedance that prevents fluid flow through the frits 438, 456 at low pressures. This ensures that the samples remain isolated within the sample loading channels 454A-454N during the sample loading procedure. Following sample loading, the sample loading ports 428A-428N are again sealed (e.g., with an external interface) and solvent flow is re-initiated to carry the samples onto the separation columns 439A-439N defined in the seventh layer 417.

While the bulk of the sample and solvent that is supplied to each column 439A-439N travels downstream through the columns 439A-439N, a small split portion of each travels upstream through the columns in the direction of the waste port 485. The split portions of sample and solvent from each column that travel upstream are consolidated into a single waste stream that flows through the slurry distribution network 476, through a portion of the slurry channel 472, then through the short waste segment 472A, vias 474C, 474B, a frit 436, a via 484A, a waste channel 485, vias 486A-486E, and through the waste port 486 to exit the device 400. The purpose of providing both an upstream and downstream path for each sample is to prevent undesirable cross-contamination from one separation run to the next, since this arrangement prevents a portion of a sample from residing in the sample loading channel during a first run and then commingling with another sample during a subsequent run.

Either isocratic separation (in which the mobile phase composition remains constant) or, more preferably, gradient separation (in which the mobile phase composition changes with time) may be performed. Following separation, the eluate may be analyzed by flow-through detection techniques and/or collected for further analysis. Various types of detection may be used, such as, but not limited to, optical techniques including UV-Visible detection and spectrometric techniques including mass spectrometry.

Microfluidic Device Interfaces and Related Systems

To overcome various limitations of known interfaces, preferred fluidic interfaces according to the present invention are gasketless and utilize non-elastomeric materials. Preferably a microfluidic device included within such an interface (e.g., the multi-column microfluidic separation device 400 described previously) has a plastically deformable outer layer that defines as least one fluidic port or opening. An external mating surface having a protruding feature is aligned with the fluidic port defined in the outer surface of the microfluidic device. An actuator coupled to the mating surface may be provided to depress at least a portion of the protruding feature into the outer layer adjacent to the fluidic port. (Or, as will be recognized to the skilled artisan, an equivalent result may be obtained by depressing the outer layer of a microfluidic device into at least a portion of a protruding feature defined by an external mating surface.) Preferably, the protruding feature plastically deforms the outer layer to form a reverse impression or indentation of the protruding feature in the outer layer. The magnitude of the compressive force, the surface area of the protruding feature, and/or the geometry of the protruding feature may be adjusted to affect the contact pressure and thereby provide a desired level of sealing. In one embodiment, the protruding feature is a continuous raised feature, such as an annulus, surrounding the fluidic port to promote even contact pressure distribution and eliminate easy pathways for fluid leakage.

Protruding features may be provided in various shapes, including but not limited to annular, cylindrical, and cubic shapes. Individual protruding features may include fluidic passages intended to convey fluid to a desired location, or protruding features may lack passages to serve as plugs or stops to block fluid flow. A fluidic interface preferably prevents fluid leakage along a contact plane while either permitting or preventing fluid transmission through the protruding feature depending on whether a fluidic passage is provided. In one embodiment, a fluidic interface includes multiple protruding features to permit simultaneous (parallel) interface with multiple fluidic ports defined in a microfluidic device.

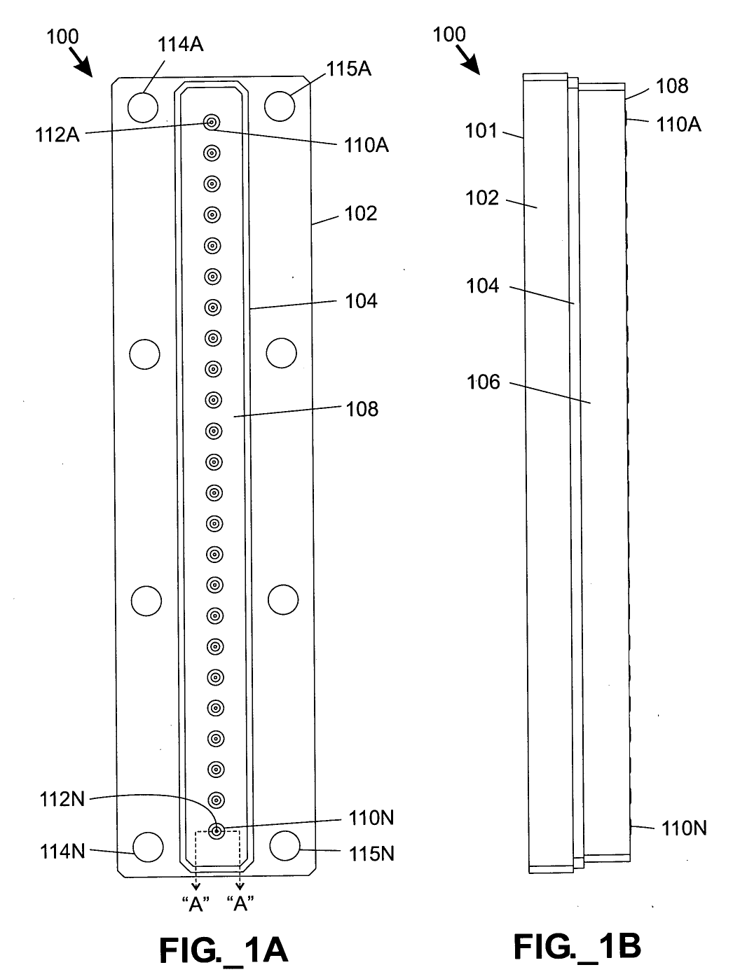

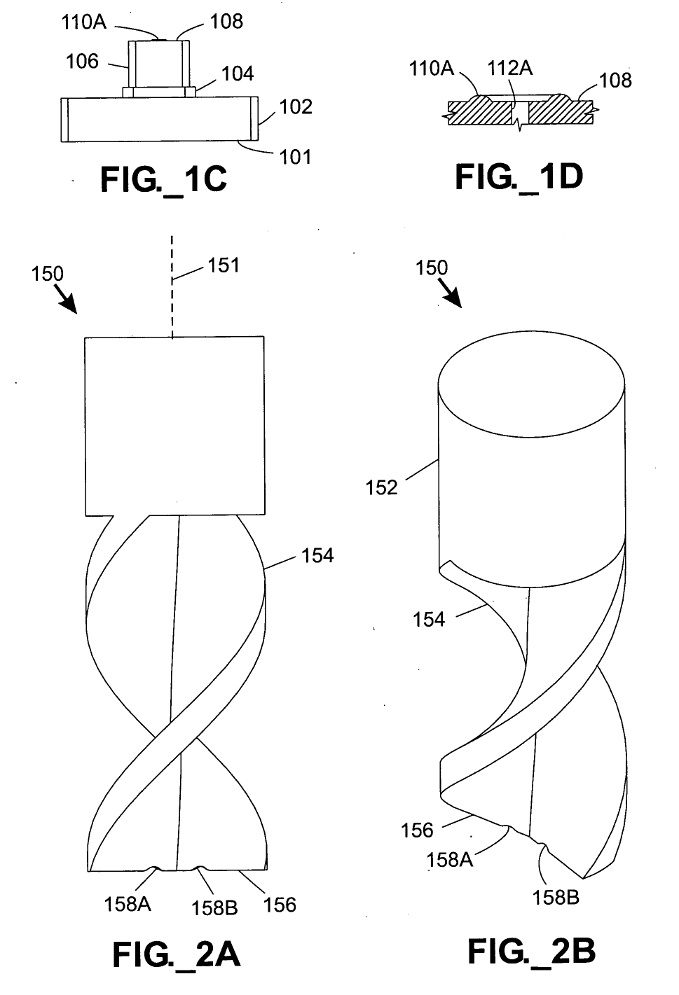

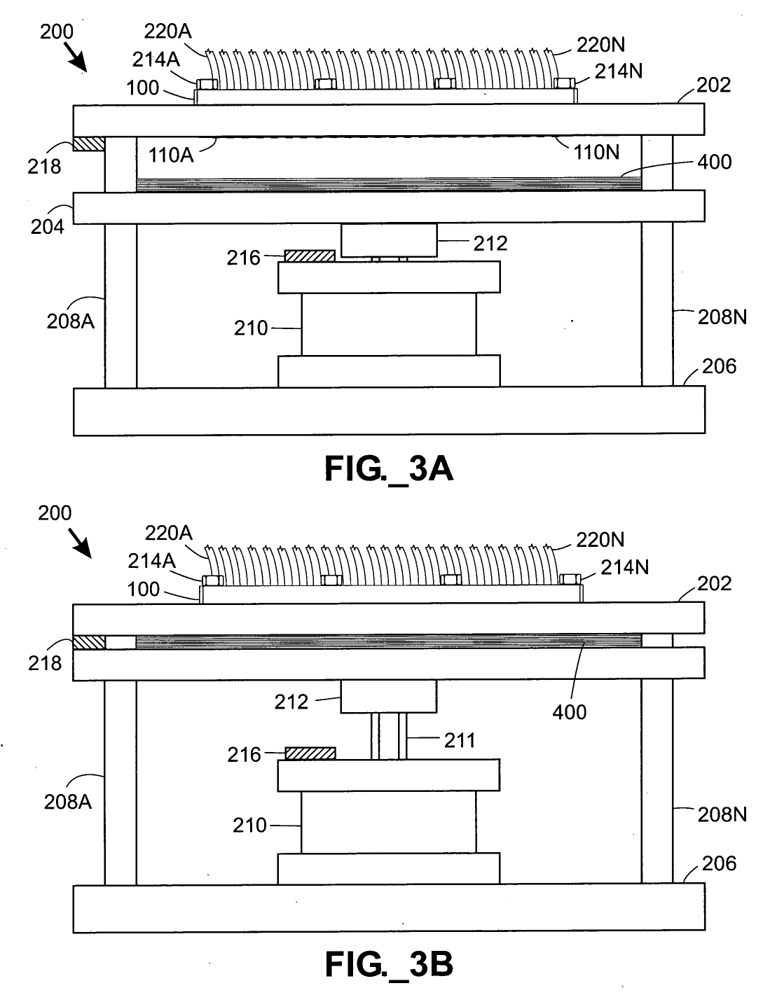

An interface may utilize a multi-channel seal plate in which the protruding features are defined. One example of a multi-channel seal plate is illustrated in FIGS. 1A-1D. The seal plate 100 includes twenty-four annular protrusions 110A-110N each surrounding a different fluidic conduit 112A-112N defined through the entire thickness of the seal plate. Fluidic conduits such as tubes (not shown) which may be attached by conventional means including, but not limited, press-fitting or threaded engagement. Each protrusion has nominal diameter of about 70 mils (1.75 mm) and a height of about six mils (150 microns) based upon a radial cross-section of about twelve mils (300 microns). The seal plate 100 includes a base portion 102 defining four mounting holes 114A-114N, 115A-115N along each side, such as may be used for receiving bolts (e.g., mounting bolts 214A-214N as shown in FIGS. 3A-3B or equivalent fastening means). The seal plate 100 further includes riser portion 106 defining a mating (upper) surface 108 from which with the protrusions 112A-112N are raised. The transition from the base portion 102 to the riser portion 106 includes a shoulder portion 104 around the periphery of the shoulder portion 104.

While various materials may be used to fabricate the seal plate, preferred materials are compatible with (i.e., non-absorptive of and non-degrading when placed into contact with chemicals typically used for performing liquid chromatography, including water, methanol, ethanol, isopropanol, acetonitrile, ethyl acetate, and dimethyl sulfoxide. The material(s) with which the seal plate 100 is fabricated are preferably harder than the material of the outer layer of a microfluidic device (e.g., device 400) intended to mate with the seal plate 100 for wear resistance and to ensure that any plastic deformation caused by the interface occurs in the outer layer of the microfluidic device 400. For example, if a microfluidic device 400 for use with the seal plate 100 includes an outer layer fabricated with polypropylene, then preferred materials for fabricating the seal plate 100 include, but are not limited to, poly (ether-ether-ketone) (“PEEK”), stainless steel, and anodized aluminum.

Although the device 100 is illustrated with protrusions 110A-110N having an annular shape, other shapes may be substituted. In one embodiment, solid cylindrical protrusions (i.e., lacking fluidic passages therethrough) may be substituted to provide sealing utility. This may be advantageous, for example, in providing an intermittent seal along a sample loading ports of a microfluidic separation device (e.g., ports 428A-428N defined in the device 400), such that sample ports may be exposed to receive sample when a seal plate is retracted, but leakage of sample from the ports is prevented when the seal plate is extended and compressed against the outer surface of such a separation device.

While various methods may be used to fabricate a seal plate having one or more protruding features, it can be difficult to fabricate high-tolerance protrusions of extremely small dimensions—particularly when fabricating protrusions having annular shapes. One method for overcoming this difficulty includes modifying a conventional endmill to permit annular protruding features to be fabricated by rotary cutting. A modified endmill 150 is illustrated in FIGS. 2A-2B. The endmill 150 has a central axis 151 and includes a shaft portion 152, flutes 154, and a cutting surface 156. Two indentations 158A, 158B are defined in the cutting surface 156, with each indentation 158A, 158B being equidistant from the central axis 151. The protruding features 110A-110N of the seal plate 100 may be defined using the modified endmill 150 by providing a workpiece (e.g., a solid block of an appropriate material) and then rotary cutting the workpiece using the endmill 150 to define the features 110A-110N. Specifically, rotary cutting using the modified endmill 150 at a first location locally exposes a first surface (e.g., surface 108) and defines a first raised annular feature (e.g., feature 110A). Repeating the process at a second location locally exposes the first surface (e.g., surface 108) and defines a second raised annular feature (e.g., feature 110N). If desired, fluidic passages 12A-112N may be defined in the seal plate 100 within the periphery of the annular features 110A-110N using any convenient means such as drilling.

As indicated previously, sealing engagement between one or more protruding features such as defined by a seal plate and a microfluidic device having a plastically deformable outer layer may be provided by depressing at least a portion of the protruding feature(s) into the outer surface of the outer layer. Preferably, a clamping apparatus including at least one actuator is provided to perform this task. One example of such a clamping apparatus 200 is illustrated in FIGS. 3A-3B together with a multi-layer microfluidic device 400. FIGS. 3A-3B provide side view schematics of the clamping apparatus in two different states of operation. The clamping apparatus 200 includes a stationary upper platen 202 suspended on peripheral support columns 208A-208N and further includes a vertically translatable lower platen 204 that is laterally constrained by the columns 208A-208N. A multi-layer microfluidic device 400 is placed between the platens 202, 204. Vertical translation of the lower platen may be facilitated by a piston-cylinder apparatus such as a pneumatic cylinder 210 (e.g., Bimba Flat-1 model FO-701.5-4R, Bimba Manufacturing Co., Monee, Ill.) operated by a feed of compressed gas from an external gas source (not shown) such as a tank of compressed nitrogen. In one embodiment, compressed nitrogen regulated to about 140 psi (965 kPa) with an external pressure regulator is supplied to a pneumatic cylinder. The pneumatic cylinder 201 includes a piston arm 211 and mounting end 212. As will be recognized by one skilled in the art, various types of actuators could be substituted for the pneumatic cylinder 210, including a hydraulic piston, a rotary screw, a solenoid, and/or a linear actuator.

A seal plate 100 (such as illustrated in and described in connection with FIGS. 1A-1D) may be affixed to the upper platen 202 using screws 214A-214N or other conventional attachment means. The mating surface 108 of the seal plate 100 should be flush with the underside of the upper platen 202 such that the protruding features 110A-1 ION protrude downward slightly from the level of the underside of the upper platen 202. Tubes or conduits 220A-220N may be mated with the seal plate 100 if the seal plate 100 includes fluidic passages (e.g., passages 112A-112N) to convey fluid.

Various sensors may be fitted to the clamping apparatus 200. In one embodiment, a compression sensor 218 may be provided to sense the magnitude of the compressive force provided by the actuator 210. In another embodiment, a translation sensor 216 may be provided to sense the relative translation distance between the microfluidic device 400 and the seal plate 100. Signals from either sensor 216, 218 or both sensors 216, 218 may be provided to a controller (not shown) to control the clamping apparatus 200 such that the operation of the actuator 210 is responsive to signals received from the sensor(s) 216, 218.

In operation of the clamping apparatus 200, a microfluidic device 400 is inserted between the platens 202, 204 in a first position with the actuator 210 in a retracted position. The microfluidic device 400 should be positioned between the platens 202, 204, such that multiple fluidic ports (e.g., outlet ports 482A-482N) will be aligned with corresponding protruding features 110A-110N defined in the seal plate 100 when the actuator 210 is extended to move the clamping apparatus 200 into a closed position around the microfluidic device 400. The actuator 210 should apply sufficient force to compress at least a portion of each of the raised features 110A-110N into a plastically deformable outer layer (e.g., layer 422) of the microfluidic device 400. This compressive contact helps prevent unintended fluidic leakage between the mating surface 108 of the seal plate 100 and the outer layer (e.g., layer 422) of the microfluidic device. The compressive force, however, should not be so great as to collapse any microfluidic channels internal to the microfluidic device 400.

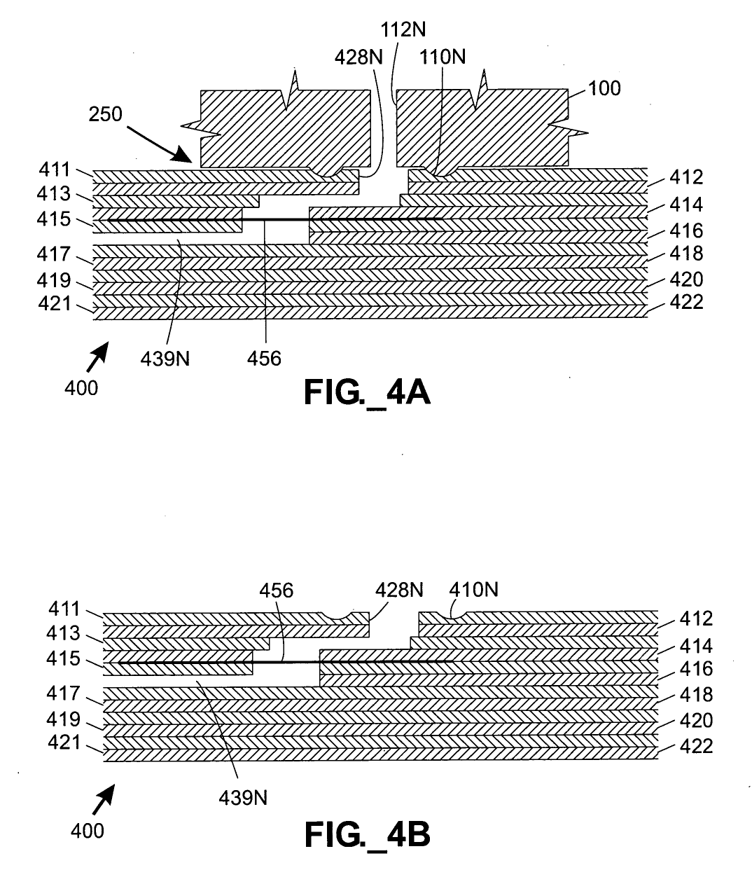

A partial cross-sectional view of a seal plate 100 mated with the microfluidic device 400 (taken along section line “B”-“B” of FIG. 5) is provided in FIG. 4A. In this instance, the protruding features 110A-110N of the seal plate 100 are aligned with the sample inlet ports 428A-428N of the microfluidic device 400. The protruding feature 110N is depressed into the outer layer 411 of the microfluidic device 400 with sufficient force to plastically deform the outer layer 411, so as to yield a reverse impression 410 in the outer layer 411 (such as shown in FIG. 4B). The resulting interface 250 between the seal plate 100 and the microfluidic device 100 is sufficient to prevent unintended fluidic leakage between the mating surface 108 of the seal plate 100 and the outer layer 411 of the microfluidic device 400 at elevated operating pressures of at least about 100 psi (690 kPa), and more preferably at least about 500 psi (3450 kPa). Preferably, however, channel collapse should be avoided to preserve the integrity of adjacent microfluidic channels (e.g., channel 439N).

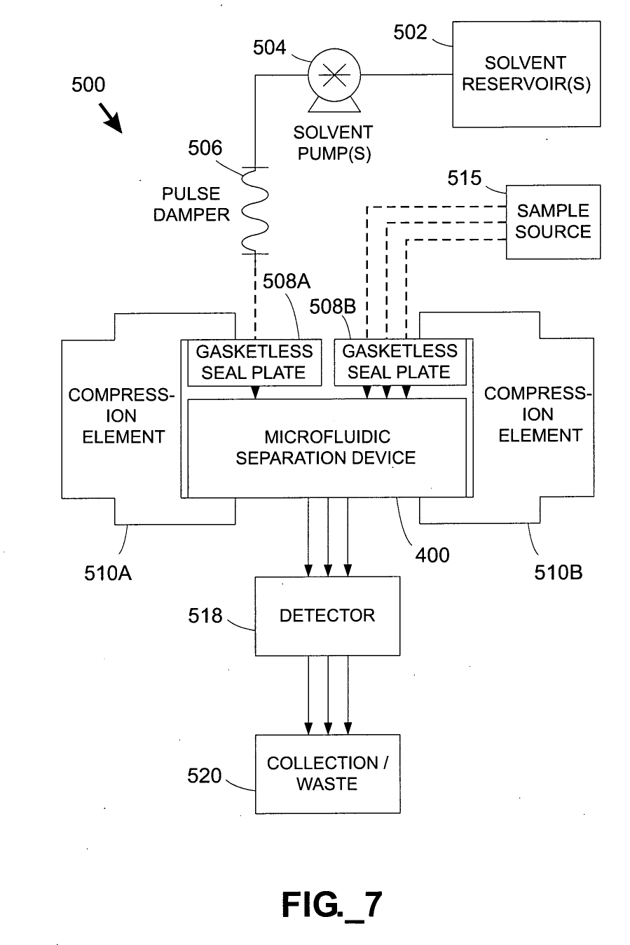

A system for performing high-throughput pressure-driven liquid chromatography and utilizing a gasketless microfluidic device interface is shown in FIG. 7. The system 500 preferably includes at least one (preferably at least two) solvent reservoir(s) 502 and pump(s) 504 for each solvent. Reservoirs 502 and pumps 504 for two or more solvents may be provided to permit operation of the system 500 in gradient mode, in which the mobile phase solvent composition is varied with respect to time during a particular separation run. Preferred pumps include conventional high pressure liquid chromatography (HPLC) pumps such as Alcott Model 765 HPLC pumps with microbore heads (Alcott Chromatography, Norcross, Ga.). A pulse damper 506 is preferably provided downstream of the pump(s) 504 to reduce variations in the mobile phase solvent supply pressure. A conventional micromixer (not shown) may be disposed between the pulse damper 506 and a multi-column microfluidic separation device 400 (such as illustrated in and described in connection with FIG. 5 and FIGS. 6A-6E). A sample source 515 is also provided to provide samples to the microfluidic device 400 (preferably in parallel to permit parallel chromatographic separations of different samples). Gasketless interface with the microfluidic device 400 is provided by way of one or more gasketless seal plates 508A, 508B and one or more compression elements 510A, 510B that preferably include actuators (not shown). If desired, the seal plates 508A, 508B may be moved individually by the compression elements 510A, 510B. Individual seal plates 508A, 508B may be used to provide intermittent sample access to the device 400, to conduct mobile phase solvent to the device 400, and to convey eluate from the device 400 following chromatographic separation. Downstream of the separation device 400, and detector 518 preferably having multiple detection regions (not shown), one detection region corresponding to each separation column 439A-439N of the microfluidic device 400. While various detection technologies may be used, the detector 518 preferably includes an electromagnetic source and an electromagnetic receiver such as may be used for UV-Visible detection. Downstream of the detector 518, eluate may be collected (e.g., for further analysis) or discarded in a collection or waste region 520.

Although embodiments of the present invention has been described in detail by way of illustration and example to promote clarity and understanding, it will be apparent that certain changes and modifications may be practiced within the scope of the appended claims.

1. A gasketless fluidic interface comprising:
a microfluidic device having a plastically deformable outer layer defining a first aperture, the device further having an internal microfluidic channel disposed substantially parallel to the outer layer and in fluid communication with the first aperture;
a retractable element including a mating surface having a raised feature protruding from the mating surface; and
means for compressing the raised feature into the outer layer to plastically deform the outer layer and prevent unintended fluidic leakage between the mating surface and the outer layer adjacent to the first aperture without collapsing the internal microfluidic channel.

2. The fluidic interface of claim 1 wherein the mating surface defines a second aperture and wherein the raised feature comprises a continuous raised feature surrounding the second aperture.

3. The fluidic interface of claim 1 wherein the microfluidic device is adapted to perform pressure-driven high performance liquid chromatography.

4. The fluidic interface of claim 1 wherein the outer layer comprises a material that is substantially non-absorptive of, and is substantially non-degrading when placed into contact with, chemicals selected from the group consisting of: water, methanol, ethanol, isopropanol, acetonitrile, ethyl acetate, and dimethyl sulfoxide.

5. The fluidic interface of claim 1 wherein the outer layer is adhesivelessly bound to the microfluidic device.

6. The fluidic interface of claim 1 wherein the outer layer comprises a substantially optically transmissive material.

7. The fluidic interface of claim 1 wherein the outer layer comprises a polyolefin material.

8. The fluidic interface of claim 1 wherein the mating surface comprises a first material having a first hardness, the outer layer comprises a second material having a second hardness, and the first hardness is greater than the second hardness.

9. The fluidic interface of claim 1 wherein the compressing means comprises a moveable element selected from the group consisting of: a pneumatic piston, a hydraulic piston, a rotary screw, a solenoid, and a linear actuator.

10. The fluidic interface of claim 1 wherein the compressing means is capable of applying a compressive force and translating any of the mating surface or the outer layer by a distance, the fluidic interface further comprising a sensor for sensing any of the magnitude of the compressive force and the translation distance.

11. A gasketless fluidic interconnect comprising:
a substantially planar microfluidic device having a plurality of device layers and defining an internal microfluidic channel, the plurality of device layers including a plastically deformable outer layer defining a first aperture in fluid communication with the internal microfluidic channel;
a retractable mating surface having a protruding feature aligned with the first aperture; and
an actuator adapted to depress at least a portion of the protruding feature into, and to plastically deform, the outer layer adjacent to the first aperture to provide sealing engagement between the outer layer and the mating surface.

12. The fluidic interconnect of claim 11 wherein the microfluidic device is operated at an elevated internal operating pressure, and sealing engagement is maintained between the outer layer and the mating surface at an operating pressure of at least about 100 psi.

13. The fluidic interconnect of claim 11 wherein the microfluidic device is operated at an elevated internal operating pressure, and sealing engagement is maintained between the outer layer and the mating surface at an operating pressure of at least about 500 psi.

14. The fluidic interconnect of claim 11 wherein the mating surface defines a second aperture, the protruding feature defines a continuous outer perimeter, and the second aperture is disposed within the continuous outer perimeter.

15. The fluidic interconnect of claim 11 wherein the microfluidic device is adapted to perform pressure-driven high-performance liquid chromatography.

16. The fluidic interconnect of claim 11 wherein each of the outer layer and the mating surface comprises at least one material that is substantially non-absorptive of, and is substantially non-degrading when placed into contact with, chemicals selected from the group consisting of: water, methanol, ethanol, isopropanol, acetonitrile, ethyl acetate, and dimethyl sulfoxide.

17. The fluidic interconnect of claim 11 wherein the outer layer comprises a substantially optically transmissive material.

18. The fluidic interconnect of claim 11 wherein the outer layer comprises a polyolefin material.

19. The fluidic interconnect of claim 11 wherein the mating surface comprises a first material having a first hardness, the outer layer comprises a second material having a second hardness, and the first hardness is greater than the second hardness.

20. The fluidic interconnect of claim 11 wherein the actuator comprises any of a pneumatic piston, a hydraulic piston, a rotary screw, a solenoid, and a linear actuator.

21. The fluidic interconnect of claim 11 wherein the actuator is capable of applying a compressive force and translating any of the mating surface or the outer layer by a distance, the fluidic interface further comprising a sensor for sensing any of the magnitude of the compressive force and the translation distance.

22. A method for interfacing with a microfluidic device, the method comprising the steps of:
providing a multi-layer, substantially planar microfluidic device defining an internal microfluidic channel and having a plastically deformable outer layer, the outer layer defining an first aperture in fluid communication with the channel;
providing a mating surface having at least one protruding feature;
aligning the protruding feature with the aperture; and
depressing at least a portion of the protruding feature into the outer layer to plastically deform the outer layer adjacent to the aperture and thereby prevent unintended leakage between the mating surface and the outer layer.

23. The method of claim 22 wherein the at least one protruding surface defines a second aperture, the method further comprising the step of either supplying or receiving a pressurized fluid through the second aperture.

24. The method of claim 22 wherein the depressing step includes the application of a compressive force, the method further comprising the step of sensing the magnitude of the compressive force, wherein the depressing step is responsive to the sensing step.

25. The method of claim 22 wherein the depressing step includes translating any of the mating surface or the outer layer by a distance, the method further comprising the step of sensing the translation distance, wherein the depressing step is responsive to the sensing step.

26. A system for performing high throughput pressure-driven liquid chromatography, the system comprising:
a microfluidic device having a plastically deformable outer layer defining a plurality of apertures, the device further having a plurality of parallel separation columns in fluid communication with the plurality of apertures;
a retractable seal plate including a mating surface having a plurality of raised features protruding from the mating surface; and
an actuator adapted to depress at least a portion of the plurality of raised features into, and to plastically deform, the outer layer adjacent to the plurality of apertures to provide sealing engagement between the outer layer and the mating surface.

27. The system of claim 26, further comprising at least one pressure source in fluid communication with the plurality of parallel separation columns.

28. The system of claim 27, further comprising a fluidic distribution network permitting fluid communication between the at least one pressure source and the plurality of separation columns.

29. The system of claim 28 wherein the fluidic distribution network is disposed within the microfluidic device.

30. The system of claim 26 wherein each of the outer layer and the mating surface comprises at least one material that is substantially non-absorptive of, and is substantially non-degrading when placed into contact with, chemicals selected from the group consisting of: water, methanol, ethanol, isopropanol, acetonitrile, ethyl acetate, and dimethyl sulfoxide.

31. A method for manufacturing a fluidic seal plate comprising a plurality of aperture-defining raised annular features protruding from a first surface, the method comprising the steps of:
providing a workpiece;
providing an endmill including a cutting surface having a center, the at least one cutting surface defining at least two indentations disposed substantially equidistantly from the center;
rotary cutting the workpiece using the endmill to expose the first surface at a first location and to define a first raised annulus protruding from the first surface;
rotary cutting the workpiece using the endmill to expose the first surface at a second location and to define a second raised annulus protruding from the first surface; and
defining a first aperture and a second aperture in the first surface, the first aperture being surrounded along the first surface by the first raised annulus and the second aperture being surrounded along the first surface by the second raised annulus.
